(19) United States
(12) Patent Application Publication
(10) Pub. No.: US 2019/0384455 A1
(43) Pub. Date: Dec. 19, 2019

(54) DISPLAY DEVICE WITH ELECTROSTATIC CAPACITANCE TYPE TOUCH PANEL

(71) Applicant: Sharp Kabushiki Kaisha, Sakai City (JP)

(72) Inventors: Takeshi KAMEDA, Sakai City (JP); Kohji YABUTA, Sakai City (JP); Yuhji SAAI, Sakai City (JP); Ryo MATSUDA, Sakai City (JP)

(21) Appl. No.: 16/436,982

(22) Filed: Jun. 11, 2019

Related U.S. Application Data
(60) Provisional application No. 62/684,768, filed on Jun. 14, 2018.

(51) Int. Cl. G06F 3/044

(52) U.S. Cl. CPC G06F 3/0446; G06F 3/0445

(57) ABSTRACT

A touch panel display device includes a display panel and a touch panel. The touch panel includes a plurality of first electrodes, at least one set of auxiliary electrodes, and a plurality of second electrodes. The touch panel further includes a plurality of first wires connected to ends of the plurality of first electrodes and the at least one set of auxiliary electrodes, and a plurality of second wires connected to ends of the plurality of second electrodes. Some of the plurality of first electrodes and the remaining electrodes have ends opposite to each other in an extending direction of the first electrodes and respectively connected to the first wires. The one set of auxiliary electrodes are provided between the first electrodes adjacent to each other and having opposite ends connected to the first wires, and have opposite ends connected to corresponding ones of the first wires.

### TECHNICAL FIELD

The invention to be disclosed hereinafter relates to a touch panel display device.

### BACKGROUND ART

Various techniques have been recently proposed for a display equipped with a touch panel. For example, JP 2015-148942 A discloses a touch panel display device adopting a projection electrostatic capacitance coupling system for detecting contact position.

The touch panel display device includes a substrate having an active area that serves as a touch detection area and is provided with a plurality of strip first electrodes and a plurality of strip second electrodes crossing the first electrodes. The substrate further has inactive areas provided with frame wires respectively connected to the first electrodes and the second electrodes. The frame wires for the second electrodes function as drive wires configured to receive drive voltage for scan of the second electrodes, whereas the frame wires for the first electrodes function as detection wires for detection of capacitance at each of nodes of the first electrodes and the second electrodes.

All the second electrodes are connected to the drive wires disposed in one of two inactive areas facing each other with the second electrodes interposed therebetween. The first electrodes are connected to the detection wires disposed in one of two inactive areas facing each other with the first electrodes interposed therebetween. Some of the first electrodes have first ends connected to the detection wires whereas the remaining first electrodes have second ends connected to the detection wires.

When the touch panel display device thus configured detects contact position, the capacitance at each of the nodes of the first electrodes and the second electrodes includes a noise component in addition to capacitance according to touch operation, due to voltage variation caused by a driven display panel. The noise component included in the capacitance detected at each of the nodes needs to be removed with reference to the capacitance detected at an adjacent node on a different one of the first electrodes.

The noise component included in the capacitance detected at each of the nodes differs depending on a time constant of the detection wire connected to the first electrode including the node. In a case where the detection wire for a first one of the first electrodes and the detection wire for a second adjacent one of the first electrodes are respectively connected to ends in the inactive areas opposite to each other, the time constants of the detection wires have difference due to large difference in distance to the corresponding detection wire from the node closer to one of the ends of the first electrodes, to cause difference in noise component included in the capacitance detected at each of the nodes. Accordingly, contact position detection cannot be achieved appropriately if the capacitance detected at the node on the first one of the first electrodes is referred to for removal of the noise component in the capacitance detected at the node on the second one of the first electrodes.

### SUMMARY OF INVENTION

In order to solve the problem mentioned above, a touch panel display device to be disclosed hereinafter includes: a display panel; and a electrostatic capacitance touch panel provided on the display panel; in which the touch panel includes a substrate, a plurality of first electrodes provided at the substrate and disposed substantially in parallel with each other, at least one set of auxiliary electrodes provided in a layer including the plurality of first electrodes at the substrate, a plurality of first wires respectively connected to ends of the plurality of first electrodes and the at least one set of auxiliary electrodes, a plurality of second electrodes provided at the substrate and crossing the plurality of first electrodes and the at least one set of auxiliary electrodes in a planar view, and a plurality of second wires respectively connected to ends of the plurality of second electrodes, the plurality of second electrodes has ends adjacent to a common end in an extending direction of the second electrodes and connected to the second wires, some of the plurality of first electrodes have ends adjacent to a first end in an extending direction of the first electrodes and connected to the first wires, and remaining first electrodes have ends adjacent to a second end opposite to the first end and connected to the first wires, the one set of auxiliary electrodes are adjacent to each other and are provided between the first electrode having the end adjacent to the first end and connected to a corresponding one of the first wires and the first electrode having the end adjacent to the second end and connected to a corresponding one of the first wires, a first one of the auxiliary electrodes has an end adjacent to the first end and connected to a corresponding one of the first wires, and a second one of the auxiliary electrodes has an end adjacent to the second end and connected to a corresponding one of the first wires.

This configuration enables removal of a noise component caused by the driven display panel during contact position detection.

### BRIEF DESCRIPTION OF DRAWINGS

FIG. 1 is a sectional view showing a schematic configuration of a touch panel display device according to a first embodiment.

FIG. 2 is a plan view showing a schematic configuration of an active matrix substrate shown in FIG. 1.

FIG. 3 is a sectional view showing a schematic configuration of the touch panel shown in FIG. 1.

FIG. 4 is a plan view showing a schematic configuration of a first electrode layer shown in FIG. 3.

FIG. 5 is a plan view showing a schematic configuration of a second electrode layer shown in FIG. 3.

FIG. 6 is a pattern diagram showing schematic configurations of the first electrode layer, the second electrode layer, and an FPC according to the first embodiment.

FIG. 7 is a plan view showing part of the first electrode layer and the second electrode layer according to the first embodiment.

FIG. 8 is a plan view showing part of a first electrode layer and a second electrode layer according to a second embodiment.

FIG. 9 is a pattern diagram showing schematic configurations of a first electrode layer, a second electrode layer, and an FPC according to a third embodiment.

FIG. 10 is a plan view showing part of the first electrode layer and the second electrode layer according to the third embodiment.

FIG. 11 is a pattern diagram showing schematic configurations of a first electrode layer, a second electrode layer, and an FPC according to a modification example (2).

### DESCRIPTION OF EMBODIMENTS

A touch panel display device according to each of exemplary embodiments will be described in detail below with reference to the drawings. Identical or corresponding parts in the drawings will be denoted by identical reference signs and will not be described repeatedly. For clearer description, the drawings to be referred to below may depict simplified or schematic configurations or may not include some of constituent elements. The constituent elements in each of the drawings may not necessarily be shown in actual dimensional ratios.

### First Embodiment

(Configuration of Touch Panel Display Device)

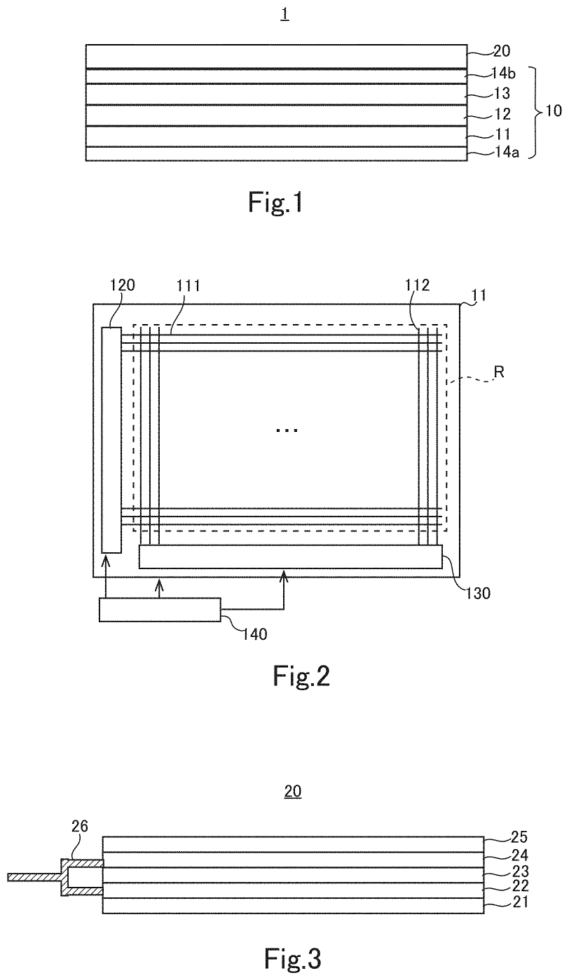

FIG. 1 is a sectional view showing a schematic configuration of the touch panel display device according to the present embodiment. A touch panel display device 1 shown in FIG. 1 includes a display panel 10 and a touch panel 20 overlapped with the display panel 10. The touch panel display device 1 according to the present example is of an out-cell type in which the touch panel 20 is bonded to a surface of the display panel 10. Configurations of the touch panel display device 1 will be specifically described below.

(Configuration of Display Panel 10)

As shown in FIG. 1, the display panel 10 includes an active matrix substrate 11, a liquid crystal layer 12, a counter substrate 13, and a pair of polarizing plates 14a and 14b.

FIG. 2 is a plan view showing a schematic configuration of the active matrix substrate 11. As shown in FIG. 2, the active matrix substrate 11 has a plurality of gate lines 111 and a plurality of source lines 112 crossing the plurality of gate lines 111. The active matrix substrate 11 is provided with a display region R including a plurality of pixels defined by the gate lines 111 and the source lines 112.

The pixels on the active matrix substrate 11 are each provided with a pixel electrode (not shown). The active matrix substrate 11 is further provided thereon with a common electrode (not shown) facing the pixel electrodes with an insulating film (not shown) interposed therebetween.

Each of the pixels is further provided with a switching element exemplarily embodied by a thin film transistor (TFT) (not shown). The TFT at each of the pixels has a gate connected to the gate line 111 for the pixel, a source connected to the source line 112 for the pixel, and a drain connected to the pixel electrode of the pixel.

The active matrix substrate 11 further includes a gate driver 120, a source driver 130, and a display control circuit 140 (none shown).

The gate driver 120 has a plurality of shift registers (not shown) respectively connected to the plurality of gate lines 111. Each of the shift registers transmits, to the gate line 111 connected to the corresponding shift register, either a selection signal bringing the gate line 111 into a selected state or a nonselection signal bringing the gate line 111 into an unselected state. The gate driver 120 sequentially switches, by means of the shift registers, the plurality of gate lines 111 into the selected state for predetermined time (e.g. a single horizontal scan period), and then switches into the unselected state.

The source driver 130 transmits, to each of the source lines 112, a data signal indicating a tone of an image to be written to the pixel provided with the gate line 111 in the selected state.

The display control circuit 140 supplies the gate driver 120 and the source driver 130 with various control signals such as a timing signal and a clock signal causing each of the gate driver 120 and the source driver 130 to be driven. The display control circuit 140 further applies predetermined voltage to the common electrode on the active matrix substrate 11.

The counter substrate 13 shown in FIG. 1 includes color filters (none shown) for colors of red (R), green (G), and blue (B) disposed at positions corresponding to the pixels.

The pixel electrode at each of the pixels holds data signal voltage supplied to the corresponding source line 112 when the gate line 111 for the pixel is in the selected state. The pixel electrodes and the common electrode form a horizontal electric field disposed therebetween and controlling an array of liquid crystal molecules in the liquid crystal layer 12, for display of an image according to the data signal voltage.

(Configuration of Touch Panel 20)

FIG. 3 is a sectional view showing a schematic configuration of the touch panel 20. As shown in FIG. 3, the touch panel 20 includes a substrate 21 provided thereon with a first electrode layer 22, an insulating layer 23, a second electrode layer 24, and a glass cover 25. The first electrode layer 22 and the second electrode layer 24 are connected to a flexible printed circuit (FPC) 26. The substrate 21 and the first electrode layer 22 interpose an adhesive layer, whereas the second electrode layer 24 and the glass cover 25 interpose another adhesive layer (none shown). These adhesive layers have translucency.

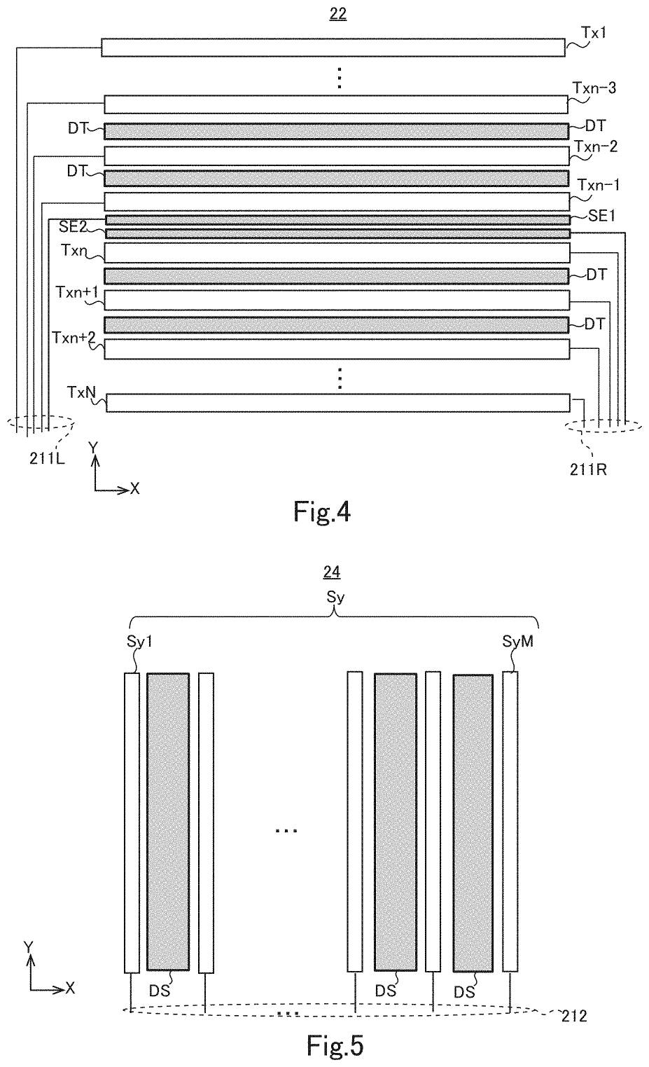

FIG. 4 is a plan view showing a schematic configuration of the first electrode layer 22. The first electrode layer 22 provided on the substrate 21 is substantially in parallel with an X axis, and includes N first electrodes Tx (Tx1 to TxN) spaced apart from one another, a plurality of dummy first electrodes DT, and one set of auxiliary electrodes SE1 and SE2. The first electrode layer 22 includes first wires 211 (211L and 211R) connected to the first electrodes Tx and the one set of auxiliary electrodes SE1 and SE2.

The N first electrodes Tx (Tx1 to TxN) include the first electrodes Tx (Tx1 to Txn−1) having ends on a left side (adjacent to a first end) in an extending direction of the first electrodes Tx in FIG. 4, the ends connected to the first wires 211L. The N first electrodes Tx (Tx1 to TxN) also include the first electrodes Tx (Txn to TxN) having ends on a right side (adjacent to a second end) in the extending direction of the first electrodes Tx in FIG. 4, the ends connected to the first wires 211R. In other words, some of the N first electrodes Tx and the remaining first electrodes Tx have opposite ends connected to the first wires 211.

As shown in FIG. 4, the first electrode Txn−1 and the first electrode Txn having opposite ends connected to the first wires 211 interpose the one set of auxiliary electrodes SE1 and SE2 spaced apart from each other. The adjacent first electrodes Tx interpose regions, and the regions except the region between the first electrode Txn−1 and the first electrode Txn are each provided with one of the dummy first electrodes DT spaced apart from the first electrodes Tx.

The auxiliary electrode SE1 has a left end connected to a corresponding one of the first wires 211L in FIG. 4, and the auxiliary electrode SE2 has a right end connected to a corresponding one of the first wires 211R in FIG. 4. Both the first electrode Txn−1 and the auxiliary electrode SE1 adjacent to the first electrode Txn−1 have the left ends connected to the first wires 211L, and both the first electrode Txn and the auxiliary electrode SE2 adjacent to the first electrode Txn have the right ends connected to the first wires 211R. The dummy first electrodes DT are not connected to the first wires 211. The first wires 211 have ends connected to neither the first electrodes Tx nor the auxiliary electrode SE1 or SE2 and extending from the first electrode layer 22 to the FPC 26 (see FIG. 3).

The second electrode layer 24 will be described next in terms of a configuration thereof. FIG. 5 is a plan view showing a schematic configuration of the second electrode layer 24.

As shown in FIG. 5, the second electrode layer 24 is substantially in parallel with a Y axis, and includes M second electrodes Sy (Sy1 to SyM) spaced apart from one another. The second electrode layer 24 further includes a plurality of dummy second electrodes DS respectively disposed in regions between the second electrodes Sy adjacent to each other.

The M second electrodes Sy (Sy1 to SyM) each have a first end connected to a corresponding one of second wires 212 and a second end extending from the second electrode layer 24 to the FPC 26 (see FIG. 3). The plurality of dummy second electrodes DS is not connected to the second wires 212.

The first electrodes Tx, the second electrodes Sy, the dummy first electrodes DT, the dummy second electrodes DS, and the auxiliary electrodes SE1 and SE2 are provided in the display region R (see FIG. 2) of the display panel 10 in a planar view. The first wires 211L are led out of the display region R into a portion of a frame region adjacent to first ends of the first electrodes Tx, and the first wires 211R are led out of the display region R into a portion of the frame region adjacent to second ends of the first electrodes Tx. The second wires 212 are led out of the display region R into a portion of the frame region adjacent to the first ends of the second electrodes Sy.

The first electrodes Tx, the dummy first electrodes DT, the auxiliary electrodes SE1 and SE2, the second electrodes Sy, and the dummy second electrodes DS according to the present example are each embodied as a meshed metal film. Each of these electrodes may alternatively be embodied as an unmeshed metal film or a transparent conductive film made of an oxide semiconductor (e.g. ITO).

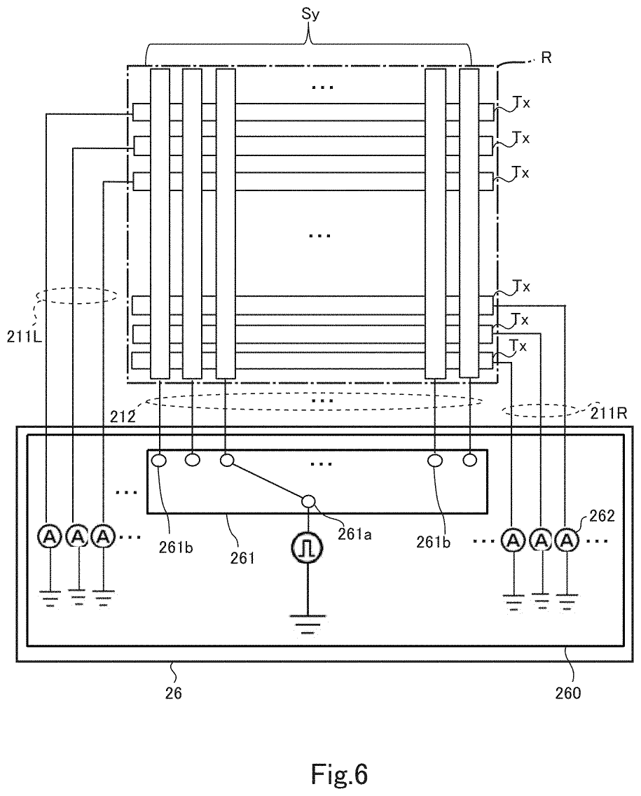

FIG. 6 is a pattern diagram showing schematic configurations of the first electrode layer 22, the second electrode layer 24, and the FPC 26. For easier depiction, FIG. 6 does not include the dummy first electrodes DT, the auxiliary electrode SE1 or SE2, or the dummy second electrodes DS.

As shown in FIG. 6, the FPC 26 is provided with a controller 260. The controller 260 includes a switching circuit 261 and a plurality of ammeters 262.

The switching circuit 261 includes a terminal 261a connected to an alternating-current power supply, and M terminals 261b connected to the M second wires 212 for the second electrodes Sy1 to SyM. The switching circuit 261 sequentially allows conduction between the terminal 261a and the M terminals 261b. The conduction between the terminal 261a and the terminals 261b causes application of drive voltage (AC voltage) to the second electrodes Sy via the second wires 212 connected to the terminals 261b. The second electrodes Sy according to the present example function as drive electrodes configured to sequentially receive drive voltage from the controller 260.

The controller 260 causes the ammeters 262 to measure current flowing to the first wires 211 in accordance with capacitance at nodes of the first electrodes Tx and the second electrodes Sy receiving drive voltage. The controller 260 detects change in capacitance at the nodes of the first electrodes Tx and the second electrodes Sy in accordance with current values measured by the ammeters 262, to detect a contact position of a finger of a user in accordance with the change in capacitance thus detected. The nodes of the first electrodes Tx and the second electrodes Sy according to the present example serve as detection targets of the contact position, and the first electrodes Tx function as sense electrodes configured to detect change in capacitance at the nodes with the second electrodes Sy. The nodes of the first electrodes Tx and the second electrodes Sy will be hereinafter referred to as detection target nodes.

The nodes of the auxiliary electrodes SE1 and SE2 shown in FIG. 4 and the second electrodes Sy are excluded from detection targets of the contact position as described above, although the driven second electrodes Sy cause current according to the capacitance at the nodes to flow also to the first wires 211 connected to the auxiliary electrodes SE1 and SE2. The present embodiment refers to the capacitance detected at the nodes of the auxiliary electrodes SE1 and SE2 and the second electrodes Sy for removal of a noise component to be described later.

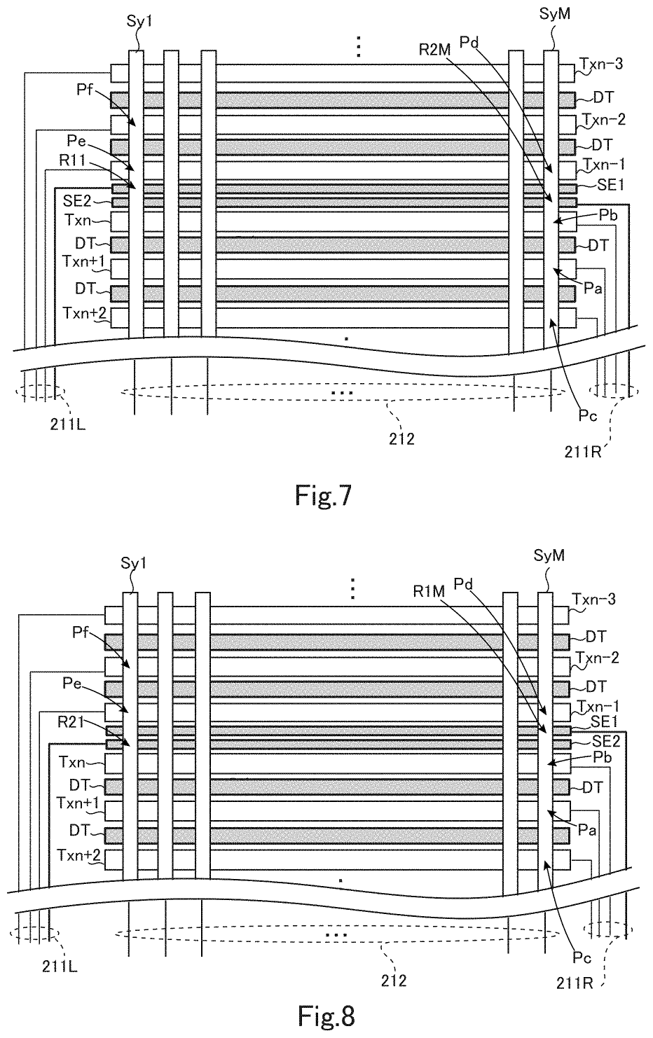

Described below is a method of detecting capacitance at the detection target nodes according to the present embodiment. The present embodiment achieves image display at the display panel 10 even while contact position detection is executed at the touch panel 20. The first wires 211 and the second wires 212 are thus influenced by voltage change at the display panel 10. The capacitance detected at each of the nodes via the corresponding one of the first wires 211 accordingly includes a noise component caused by the driven display panel 10. In order to remove the noise component, the present embodiment includes removing the noise component included in the capacitance detected at each of the detection target nodes on one of the second electrodes Sy with reference to the capacitance detected at two detection target nodes adjacent to the detection target node on the second electrode Sy. The following will describe with reference to specifically exemplary FIG. 7.

FIG. 7 is a plan view showing part of the second electrode layer 24 and the first electrode layer 22 including two of the first electrodes Tx having opposite ends connected to the first wires 211.

The present embodiment assumes that, in a state where the display panel 10 is not driven, capacitance (initial capacitance) at each of the detection target nodes is preliminarily detected in an initial state where no finger or the like of a user is in contact with the touch panel 20 and the controller 260 stores the initial capacitance at each of the detection target nodes.

In an exemplary case where a user touches a detection target node Pa with a finger or the like while the display panel 10 is driven, the controller 260 drives the second electrodes Sy to detect current according to the capacitance at the detection target nodes via the first wires 211L and 211R. Capacitance at detection target nodes Pa, Pb, and Pc according to current values detected through driving the second electrode SyM will be denoted by Ca1, Cb1, and Cc1, respectively.

The capacitance Ca1 at the detection target node Pa is decreased from the initial capacitance by capacitance ΔC (hereinafter, referred to as contact capacitance) caused by contact. The capacitance Ca1, Cb1, and Cc1 includes the initial capacitance at the detection target nodes Pa, Pb, and Pc as well as noise components Na, Nb, and Nc according to time constants of the first wires 211, respectively. The detected capacitance Ca1, Cb1, and Cc1 is accordingly indicated by expression (1) to expression (3).

Ca1=Ca0+Na−ΔC (1)

Cb1=Cb0+Na (2)

Cc1=Cc0+Nc (3)

In accordance with expression (2) and expression (3), the noise components Nb and Nc at the detection target nodes Pb and Pc are each obtained as difference between the initial capacitance and the detected capacitance.

According to the present example, first electrodes Txn, Txn+1, and Txn+2 respectively provided with the detection target nodes Pa, Pb, and Pc have right ends connected to the first wires 211R. The nodes Pa, Pb, and Pc and connection ends of the corresponding first wires 211R accordingly have equal distances therebetween. The capacitance detected at the nodes Pa, Pb, and Pc is thus regarded as being substantially equally influenced by noise components according to the time constants of the first wires 211R.

As indicated by expression (4), the noise component Na is approximated by an average value of the noise components Nb and Nc, and the contact capacitance ΔC at the node Pa is indicated by expression (5) in accordance with expression (1) and expression (4).

Na={(Cb1−Cb0)+(Cc1−Cc0)}/2 (4)

ΔC=Ca0−Ca1+{(Cb1−Cb0)+(Cc1−Cc0)}/2 (5)

As in the above exemplary case where the distances between the three adjacent detection target nodes on the single second electrode Sy and the connection ends of the first wires 211 for the detection target nodes are substantially equal to one another, the capacitance detected at the detection target nodes is regarded as being equally influenced by noise components according to the time constants of the first wires 211, and the capacitance detected at the detection target nodes is regarded as including equal noise components.

However, as the detection target nodes on the second electrode SyM in FIG. 7, the detection target node Pb on the first electrode Txn and a detection target node Pd on the first electrode Txn−1 have opposite ends connected to the first wires 211. The capacitance detected at the detection target nodes Pb and Pd is thus differently influenced by noise components according to the time constants of the first wires 211, and includes noise components not equal to each other.

The present embodiment accordingly refers to, upon obtaining contact capacitance at the detection target node Pb, detected capacitance and initial capacitance at not the detection target node Pd but a node R2M of the auxiliary electrode SE2 and the second electrode SyM. Similarly to the first electrode Txn, the auxiliary electrode SE2 has the right end connected to a corresponding one of the first wires 211R. Accordingly, the capacitance detected at the node R2M on the auxiliary electrode SE2 and the detection target node Pb is regarded as being equally influenced by noise components according to the time constants of the first wires 211R, and is regarded as including equal noise components.

In this case, the contact capacitance at the detection target node Pb can thus be obtained from the detected capacitance and the initial capacitance at the detection target nodes Pb and Pc and the node R2M in a manner similar to the manner according to expression (1) to expression (5).

FIG. 7 exemplifies obtaining the contact capacitance at the detection target node Pb closest to the right end of the first electrode Txn among the detection target nodes on the first electrode Txn. The contact capacitance at any other one of the detection target nodes on the first electrode Txn may also be obtained from the capacitance detected at a node provided on the auxiliary electrode SE2 and a node provided on the first electrode Txn+1 in accordance with a manner similar to the above.

With reference to FIG. 7, contact capacitance at a detection target node Pe of the first electrode Txn−1 and the second electrode Sy1 may be obtained from detected capacitance and initial capacitance at a node R11 of the auxiliary electrode SE1 and the second electrode Sy1 and a detection target node Pf of a first electrode Txn-2 and the second electrode Sy1. Similarly to the first electrode Txn−1, the auxiliary electrode SE1 has the left end connected to the corresponding first wire 211L. Accordingly, the capacitance detected at the detection target nodes Pe and Pf and the node R11 is regarded as being substantially equally influenced by noise components according to the time constants of the first wires 211L, and is regarded as including equal noise components. Contact capacitance at any detection target node other than the detection target node Pe on the first electrode Txn−1 may be obtained from the detected capacitance and the initial capacitance at a node provided on the auxiliary electrode SE1 and a node provided on the first electrode Txn−1.

Among the detection target nodes provided on the two first electrodes Tx having opposite ends connected to the first wires 211, the detection target nodes closer to the ends of the first electrodes Tx have larger difference in noise component included in the detected capacitance depending on difference in distance from the first wires 211 connected thereto. According to the embodiment described above, the two first electrodes Tx having opposite ends connected to the first wires 211 interpose the one set of auxiliary electrodes SE1 and SE2 extending substantially in parallel with the first electrodes Tx. The auxiliary electrodes SE1 and SE2 each have the end that is adjacent to the end provided with the first wire 211 for the adjacent first electrode Tx and is connected to the corresponding first wire 211. Accordingly, the noise components included in the capacitance detected at the detection target nodes provided on the two first electrodes Tx having opposite ends connected to the first wires 211 can be removed with reference to the capacitance detected at a node on the auxiliary electrode SE1 or SE2 having a noise component equal to the noise components at the detection target nodes. Contact position detection accuracy can thus be improved in comparison to a case of obtaining the contact capacitance at the detection target nodes on the two first electrodes Tx having opposite ends connected to the first wires 211 with reference only to the capacitance detected at an adjacent detection target node.

The first wires 211 are connected to the first electrodes Tx as well as to the auxiliary electrodes SE1 and SE2 in the above example. The first wires 211 are thus increased in the number in comparison to a case where the first wires 211 are connected only to the first electrodes Tx. All the first wires 211 are not connected to ends adjacent to a common end, but some are connected to the left ends and others are connected to the right ends. In comparison to the case of connecting all the first wires 211 to the ends adjacent to the common end, portions of the frame region adjacent to the left and right ends of the first electrodes Tx and the auxiliary electrodes SE1 and SE2 can be decreased even though the first wires 211 are connected to the auxiliary electrodes SE1 and SE2.

### Second Embodiment

FIG. 8 is a plan view showing part of the first electrode layer 22 and the second electrode layer 24 according to the present embodiment. FIG. 8 includes components that are identical to those according to the first embodiment (see FIG. 7) and are denoted by reference signs identical to those according to the first embodiment. Components different from those of the first embodiment will be mainly described below.

As shown in FIG. 8, the auxiliary electrodes SE1 and SE2 according to the present embodiment are different from those according to the first embodiment (see FIG. 7) in terms of ends connected to the first wires 211. Specifically, the corresponding first wire 211R is connected to the right end of the auxiliary electrode SE 1, whereas the corresponding first wire 211L is connected to the left end of the auxiliary electrode SE2. The first wires 211 according to the present embodiment are connected to the ends opposite to the ends of the auxiliary electrodes SE1 and SE1 according to the first embodiment.

For removal of the noise component included in the capacitance detected at the detection target node Pb, referred to in this case are the detected capacitance and the initial capacitance at a node RIM of the auxiliary electrode SE1 and the second electrode SyM as well as the detection target node Pa. For removal of the noise component included in the capacitance detected at the detection target node Pe, referred to are the detected capacitance and the initial capacitance at a node R21 of the auxiliary electrode SE2 and the second electrode Sy1 as well as the detection target node Pf.

### Third Embodiment

The above first embodiment exemplifies detection of a contact position with a finger of a user. The contact position may alternatively be detected with a known active stylus pen configured to output a drive signal from a tip of the pen. Unlike the first embodiment, both the first electrodes Tx and the second electrodes Sy function as sense electrodes in this case.

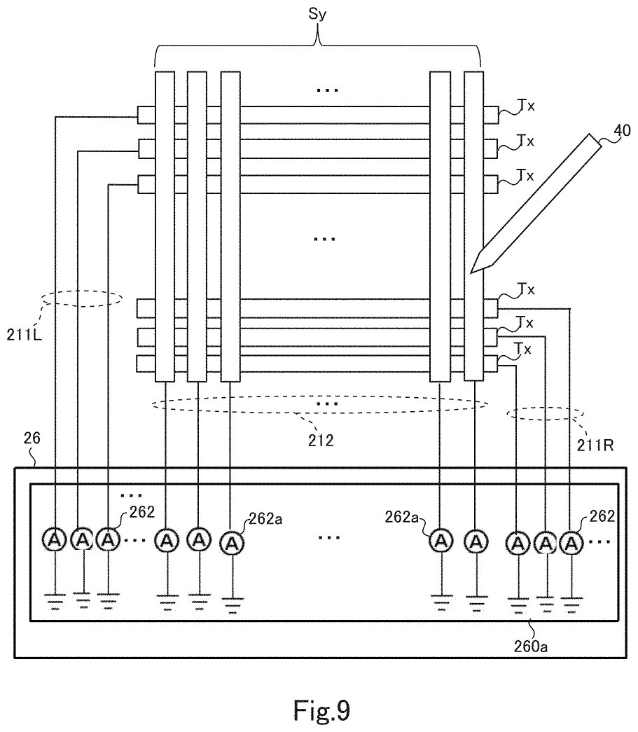

FIG. 9 is a pattern diagram showing schematic configurations of the first electrode layer 22, the second electrode layer 24, and the FPC 26 according to the present embodiment. For easier depiction, FIG. 9 does not include the dummy first electrodes DT, the auxiliary electrode SE1 or SE2, or the dummy second electrodes DS. FIG. 9 includes components that are identical to those according to the first embodiment and are denoted by reference signs identical to those according to the first embodiment.

As shown in FIG. 9, the present embodiment is different from the first embodiment (see FIG. 7) in that a controller 260a according to the present embodiment does not include the switching circuit 261 but further includes a plurality of ammeters respectively connected to the second wires 212 connected to the second electrodes Sy.

An active stylus pen 40 outputs, from a tip thereof, a drive signal having a sine wave at a low frequency of about 2 MHz. In a case where a plurality of active stylus pens 40 is provided, each drive signal to be outputted may be replaced with a modulation signal obtained by adding, to the drive signal, identification information on a corresponding one of the active stylus pens 40.

When the first electrodes Tx and the second electrodes Sy each receive a drive signal outputted from the tip of the active stylus pen 40, current according to intensity of the received signals flows to the first wires 211L and 211R and the second wires 212. The controller 260a measures current values of the first wires 211L and 211R and the second wires 212, and detects, as a contact position, a node of the first electrode Tx and the second electrode Sy having the highest signal intensity in accordance with the current values of the first wires 211L and 211R and the second wires 212.

The first wires 211 and the second wires 212 according to the present embodiment are also influenced by the driven display panel 10, and the current values measured via the first wires 211 and the second wires 212 accordingly include noise components.

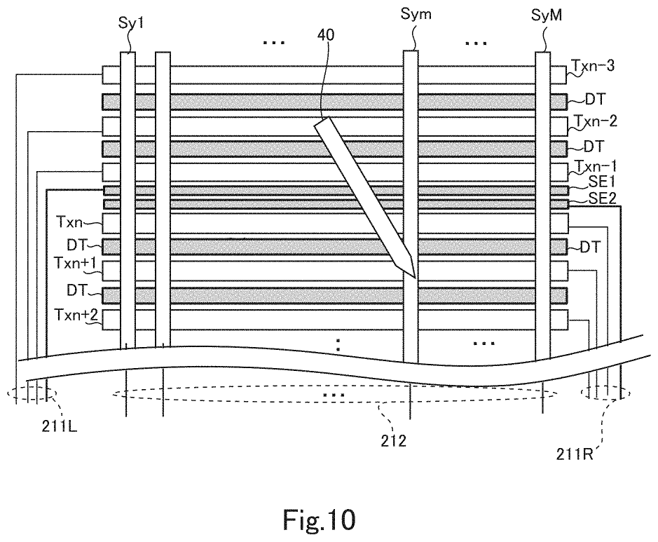

The active stylus pen 40 in contact with or adjacent to the touch panel 20 outputs a drive signal much larger in signal intensity than noise caused by the driven display panel 10. Any noise component caused by the driven display panel 10 and included in the current value can be disregarded in this case. In a case where the active stylus pen 40 is in a hovering state, in other words, when the drive signal received by each of the first electrode Tx and the second electrode Sy has intensity equal to or less than a predetermined level, the noise component has larger influence to cause erroneous detection of the contact position or the like. In a case where the current values measured via the first wires 211 and the second wires 212 are equal to or less than a predetermined reference value, the noise components included in the current values are reduced in the following manner in the present embodiment. The following will describe specifically with reference to FIG. 10.

Assume that the active stylus pen 40 is in the hovering state at the node of the first electrode Txn+1 and a second electrode Sym in FIG. 10. In this case, the current values measured via the first wires 211 and the second wires 212 include a highest current value In+1 of the first wire 211 (hereinafter, a first wire 211n+1) connected to the first electrode Txn+1 and another highest current value Im of the second wire 212 (hereinafter, a second wire 212m) connected to the second electrode Sym. The current values In+1 and Im are defined as follows.

In+1=Pen(n+1)+Nn+1 (1A)

Im=Pen(m)+Nm (1B)

The above values Pen(n+1) and Pen(m) are components (hereinafter, received components) of the drive signals received by the first electrode Txn+1 and the second electrode Sym, respectively. The above values Nn+1 and Nm are noise components, caused by the driven display panel 10, according to the time constants of the first wire 211n+1 and the second wire 212m, respectively.

The present embodiment adopts current values (In and In+2) measured via the first wires 211R connected to the first electrode Txn and the first electrode Txn+2 adjacent to the first electrode Txn+1, in order to reduce the noise component Nn+1. The present embodiment also adopts current values (Im+1 and Im−1) measured via the second wires 212 connected to a second electrode Sym−1 and a second electrode Sym+1 adjacent to the second electrode Sym, in order to reduce the noise component Nm. Similarly to the current values In+1 and Im, the current values In, In+2, Im+1, and Im−1 can be defined as follows.

In=Pen(n)+Nn (2A)

In+2=Pen(n+2)+Nn+2 (3A)

Im−1=Pen(m−1)+Nm−1 (2B)

Im+1=Pen(m+1)+Nm+1 (3B)

As described in the first embodiment, the first wires 211R according to the present example are connected to the right ends of the first electrodes Txn, Txn+1, and Txn+2 and are adjacent to one another, so that the first wires 211 are regarded as having equal time constants. The second wires 212 are connected to all the second electrodes Sy from an identical portion of the frame region. The second wires 212 for the second electrodes Sy adjacent to each other are thus regarded as having equal time constants.

Similarly to the first embodiment, the noise component Nn+1 is approximated with reference to the noise components Nn and Nn+2, and the noise component Nm is approximated with reference to the noise components Nm−1 and Nm+1. In expression (2A) and expression (3A), the drive signals received by the first electrode Txn and the first electrode Txn+2 respectively include received components Pen(n) and Pen(n+2) extremely smaller than the received component Pen(n+1) included in the drive signal received by the first electrode Txn+1. By approximating these received components by zero, the current values In and In+2 can be indicated by the following expressions.

In≈Nn (2A′)

In+2≈Nn+2 (3A′)

Through approximating the noise component Nn+1 in accordance with expression (2A′) and expression (3A′), expression (1A) is modified to expression (1A′).

In+1≈Pen(n+1)+{(In+In+2)/2}

Pen(n+1)≈In+1−{(In+In+2)/2} (1A′)

Expression (1B) is modified to expression (1B′) through similarly approximating the noise component Nm with reference to the current values of the adjacent second electrodes Sym−1 and Sym+1.

Pen(m)≈Im−{(Im−1+Im+1)/2} (1B′)

In a case where the active stylus pen 40 is in the hovering state on the first electrode Txn, the received component at the first electrode Txn is obtained with reference to the current value detected via the first wire 211 connected to not the first electrode Txn−1 but the auxiliary electrode SE2. The reason therefor is similar to that described in the first embodiment. The first wire 211L for the first electrode Txn−1 and the first wire 211R for the first electrode Txn are disposed in opposite portions of the frame region, so that these first wires 211 have different time constants. The first wire 211R for the auxiliary electrode SE2 and the first wire 211R for the first electrode Txn are connected on the end in the same portion of the frame region, and these first wires 211R are thus regarded as having equal time constants. Reference to the current value detected via the first wire 211 for the auxiliary electrode SE2 accordingly achieves improvement in contact position detection accuracy.

In another case where the active stylus pen 40 is in the hovering state on the first electrode Txn−1, the received component at the first electrode Txn−1 is similarly obtained with reference to the current value detected via the first wire 211L connected to the auxiliary electrode SE1.

### MODIFICATION EXAMPLES

The embodiments described above are merely exemplified for implementation of the present invention. The present invention should not be limited to the above embodiments, but can be implemented with appropriate modifications to any of the above embodiments without departing from the spirit of the present invention.

(1) Each of the above embodiments exemplifies the out-cell touch panel display device including the touch panel 20 bonded to the surface of the display panel 10. The present invention may also be applicable to an on-cell touch panel display device including the touch panel 20 disposed between the counter substrate 13 and the polarizing plate 14b of the display panel 10.

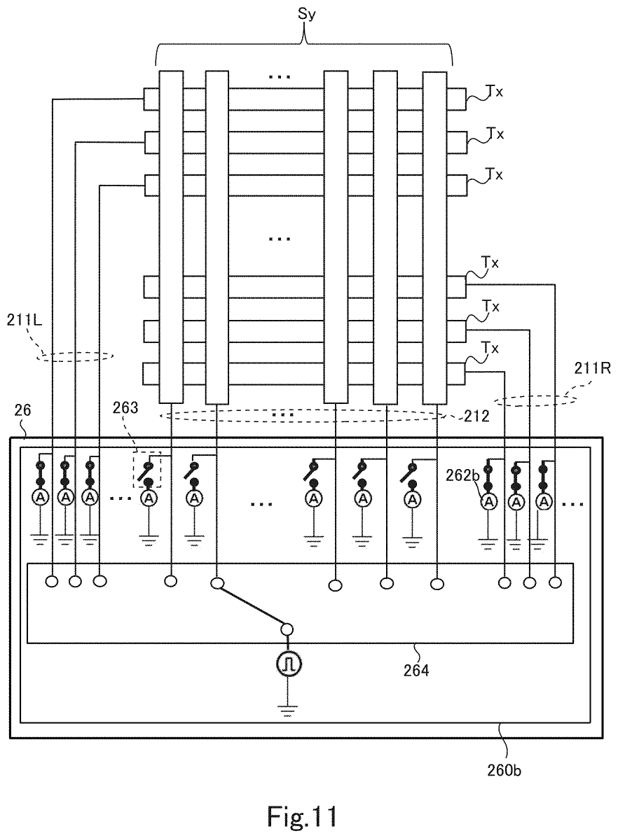

(2) Each of the above embodiments exemplifies the case where the first electrodes Tx function as drive electrodes and the second electrodes Sy function as sense electrodes. Alternatively, the functions of the drive electrodes and the sense electrodes may be switched to each other. FIG. 11 exemplarily shows a controller 260b that includes switches 263 respectively connected to the first wires 211 and the second wires 212 and configured to switch functions as sense electrodes or drive electrodes, and the switches 263 are connected to ammeters 262b. The controller 260b further includes a switching circuit 264 configured to supply a drive signal to either the first wires 211 or the second wires 212. Both the first electrodes Tx and the second electrodes Sy can function as sense electrodes in this configuration.

(3) Each of the above embodiments exemplifies providing the plurality of first electrodes Tx having opposite ends connected to the first wires 211. The present invention is also applicable to a case of providing at least one of the first electrodes Tx.

(4) Each of the above embodiments exemplifies the touch panel 20 provided with the dummy first electrodes DT and the dummy second electrodes DS, which are not necessarily provided in the present invention.

(5) Each of the above embodiments exemplifies providing the single position in the first electrodes Tx having change of the ends connected to the first wires 211. The first electrodes Tx may alternatively have a plurality of such positions. As in any one of the above embodiments, each of the positions of the first electrodes Tx having the change of the ends connected to the first wires 211 may be provided with the one set of auxiliary electrodes SE1 and SE2 connected to the first wires 211.

(6) Each of the above embodiments exemplarily adopts the touch panel 20 including the first electrode layer 22 and the second electrode layer 24 disposed on an identical surface of the substrate 21. The touch panel 20 may alternatively include the first electrode layer 22 provided on a first surface of the substrate 21 and the second electrode layer 24 provided on a second surface of the substrate 21.

The configurations disclosed herein can also be described as follows.

A touch panel display device according to a first configuration of the present invention includes: a display panel; and a electrostatic capacitance touch panel provided on the display panel; in which the touch panel includes a substrate, a plurality of first electrodes provided at the substrate and disposed substantially in parallel with each other, at least one set of auxiliary electrodes provided in a layer including the plurality of first electrodes at the substrate, a plurality of first wires respectively connected to ends of the plurality of first electrodes and the at least one set of auxiliary electrodes, a plurality of second electrodes provided at the substrate and crossing the plurality of first electrodes and the at least one set of auxiliary electrodes in a planar view, and a plurality of second wires respectively connected to ends of the plurality of second electrodes, the plurality of second electrodes has ends adjacent to a common end in an extending direction of the second electrodes and connected to the second wires, some of the plurality of first electrodes have ends adjacent to a first end in an extending direction of the first electrodes and connected to the first wires, and remaining first electrodes have ends adjacent to a second end opposite to the first end and connected to the first wires, the one set of auxiliary electrodes are adjacent to each other and are provided between the first electrode having the end adjacent to the first end and connected to a corresponding one of the first wires and the first electrode having the end adjacent to the second end and connected to a corresponding one of the first wires, a first one of the auxiliary electrodes has an end adjacent to the first end and connected to a corresponding one of the first wires, and a second one of the auxiliary electrodes has an end adjacent to the second end and connected to a corresponding one of the first wires (a first configuration).

The touch panel according to the first configuration includes the plurality of first electrodes, the plurality of second electrodes crossing the plurality of first electrodes in a planar view, and the at least one set of auxiliary electrodes disposed in the layer including the first electrodes and crossing the second electrodes in a planar view. The second electrodes have the ends adjacent to the common end and respectively connected to the second wires. The ends of the first electrodes and the at least one set of auxiliary electrodes are respectively connected to the first wires. Some of the plurality of first electrodes have the ends adjacent to the first end in the extending direction of the first electrodes and connected to the first wires, and the remaining first electrodes have the ends adjacent to the second end opposite to the first end and connected to the first wires. The one set of auxiliary electrodes are provided between the first electrodes adjacent to each other having opposite ends connected to the first wires, among the plurality of first electrodes. The first one of the auxiliary electrodes has the end adjacent to the first end and connected to a corresponding one of the first wires, and the second one of the auxiliary electrodes has the end adjacent to the second end and connected to a corresponding one of the first wires.

Upon detection of electrostatic capacitance at any one of the nodes of the first electrodes and the second electrodes via a corresponding one of the first wires or a corresponding one of the second wires, the first wire and the second wire are likely to be influenced by noise caused by the driven display panel. Electrostatic capacitance at the node detected via the first wire includes a noise component according to the time constant of the first wire. Among the nodes on two of the first electrodes having opposite ends connected to the first wires, the nodes closer to the first end of the first electrodes have larger difference in time constant of the first wires and larger difference in noise component included in the detected capacitance. It is accordingly difficult to remove the noise component at each of the nodes with reference to electrostatic capacitance at adjacent nodes on the two first electrodes. The present configuration includes the one set of auxiliary electrodes provided between the two first electrodes, and the auxiliary electrodes and the second electrodes have nodes. The two first electrodes have ends that are adjacent to the end of any one of the one set of auxiliary electrodes connected to the corresponding first wire, and are connected to the first wires. The nodes on the first electrode and the auxiliary electrode having same ends connected to the first wires are equal in noise component. The noise components included in detection results at the nodes on the two first electrodes can thus be removed with reference to a detection result at the node on one of the one set of auxiliary electrodes.

The present configuration includes the first wires for the auxiliary electrodes, so that the first wires are increased in the number by at least two in comparison to a case of providing the first wires only for the first electrodes. Some of the first wires are connected to the ends opposite to the ends connected to the remaining first wires. In other words, all the first wires are not connected to the ends adjacent to the common end. Portions of the frame region adjacent to the both ends of the first electrodes and the auxiliary electrodes can thus be decreased in comparison to the case of connecting all the first wires 211 to the ends adjacent to the common end.

Optionally, in the first configuration, the touch panel further includes a plurality of dummy first electrodes provided substantially in parallel with the first electrodes, in the layer including the plurality of first electrodes, respectively in regions between the first electrodes adjacent to each other, except a region including the at least one set of auxiliary electrodes, and a plurality of dummy second electrodes provided substantially in parallel with the second electrodes, in a layer including the plurality of second electrodes, respectively in regions between the second electrodes adjacent to each other (a second configuration).

The second configuration includes the dummy first electrodes substantially parallel to the first electrodes and respectively provided in the regions between the first electrodes adjacent to each other, except the region including the one set of auxiliary electrodes. The dummy second electrodes substantially parallel to the second electrodes are respectively provided in the regions between the second electrodes adjacent to each other. The first electrodes and the second electrodes are less likely to be visually recognized in comparison to a case of providing neither the dummy first electrodes nor the dummy second electrodes.

Optionally, in the first or second configuration, the touch panel further includes a controller connected to the plurality of first wires and the plurality of second wires, the controller sequentially supplies the plurality of second wires with a drive signal, acquires, via the plurality of first wires, signals according to electrostatic capacitance at nodes of the plurality of first electrodes as well as the at least one set of auxiliary electrodes and the plurality of second electrodes, and detects a contact position at any one of nodes of the plurality of first electrodes and the plurality of second electrodes in accordance with the acquired signals (a third configuration).

The third configuration enables contact position detection in accordance with the signals acquired from the first wires connected to the plurality of first electrodes as well as the signals acquired from the first wires connected to the auxiliary electrodes. This configuration achieves improvement in contact position detection accuracy in comparison to a case of detecting the contact position in accordance with only the signals acquired from the first wires connected to the plurality of first electrodes.

Optionally, in the first or second configuration, the touch panel receives touch operation by means of an active pen configured to output a drive signal, the touch panel further includes a controller connected to the plurality of first wires and the plurality of second wires, the plurality of first electrodes, the at least one set of auxiliary electrodes, and the plurality of second electrodes each receive the drive signal, the controller acquires, via the plurality of first wires and the plurality of second wires, signals according to signal intensity of the drive signals received by the plurality of first electrodes, the at least one set of auxiliary electrodes, and the plurality of second electrodes, and detects a contact position of the active pen at any one of nodes of the plurality of first electrodes and the plurality of second electrodes in accordance with the acquired signals (a fourth configuration).

According to the fourth configuration, the contact position of the active pen is detected in accordance with the signals according to the signal intensity of the drive signals received by the plurality of first electrodes, the at least one set of auxiliary electrodes, and the plurality of second electrodes. This configuration achieves improvement in contact position detection accuracy in comparison to a case of detecting the contact position in accordance with only the signals acquired from the first wires connected to the plurality of first electrodes and the second wires connected to the plurality of second electrodes.

Optionally, in the third or fourth configuration, the controller removes a noise component included in a signal acquired from each of the first wires in accordance with a signal acquired from the first wire for at least a remaining one of the first electrodes having an end that is adjacent to the end connected to the first wire and is connected to a corresponding one of the first wires, or signals acquired from the first wire for the at least one remaining first electrode and the first wire for the auxiliary electrode having an end that is adjacent to the end connected to the first wire and is connected to a corresponding one of the first wires (a fifth configuration).

The fifth configuration enables removal of the noise components according to the time constants of the first wires included in the signals acquired via the first wires for the plurality of first electrodes, and thus achieves improvement in contact position detection accuracy.

Optionally, in any one of the first to fifth configurations, the plurality of first electrodes and the at least one set of auxiliary electrodes are provided on a first surface of the substrate, and the plurality of second electrodes is provided on a second surface of the substrate (a sixth configuration).

Optionally, in any one of the first to fifth configurations, the touch panel further includes an insulating layer, the plurality of first electrodes, the at least one set of auxiliary electrodes, the plurality of second electrodes, and the insulating layer are provided on a first surface of the substrate, and the insulating layer is disposed between the plurality of first electrodes as well as the at least one set of auxiliary electrodes and the plurality of second electrodes (a seventh configuration).

1. A touch panel display device comprising:
a display panel; and
a electrostatic capacitance touch panel provided on the display panel; wherein
the touch panel includes
a substrate,
a plurality of first electrodes provided at the substrate and disposed substantially in parallel with each other,
at least one set of auxiliary electrodes provided in a layer including the plurality of first electrodes at the substrate,
a plurality of first wires respectively connected to ends of the plurality of first electrodes and the at least one set of auxiliary electrodes,
a plurality of second electrodes provided at the substrate and crossing the plurality of first electrodes and the at least one set of auxiliary electrodes in a planar view, and
a plurality of second wires respectively connected to ends of the plurality of second electrodes,
the plurality of second electrodes has ends adjacent to a common end in an extending direction of the second electrodes and connected to the second wires,
some of the plurality of first electrodes have ends adjacent to a first end in an extending direction of the first electrodes and connected to the first wires, and remaining first electrodes have ends adjacent to a second end opposite to the first end and connected to the first wires,
the one set of auxiliary electrodes are adjacent to each other and are provided between the first electrode having the end adjacent to the first end and connected to a corresponding one of the first wires and the first electrode having the end adjacent to the second end and connected to a corresponding one of the first wires, a first one of the auxiliary electrodes has an end adjacent to the first end and connected to a corresponding one of the first wires, and a second one of the auxiliary electrodes has an end adjacent to the second end and connected to a corresponding one of the first wires.

2. The touch panel display device according to claim 1, wherein
the touch panel further includes
a plurality of dummy first electrodes provided substantially in parallel with the first electrodes, in the layer including the plurality of first electrodes, respectively in regions between the first electrodes adjacent to each other, except a region including the at least one set of auxiliary electrodes, and
a plurality of dummy second electrodes provided substantially in parallel with the second electrodes, in a layer including the plurality of second electrodes, respectively in regions between the second electrodes adjacent to each other.

3. The touch panel display device according to claim 1, wherein
the touch panel further includes a controller connected to the plurality of first wires and the plurality of second wires,
the controller sequentially supplies the plurality of second wires with a drive signal, acquires, via the plurality of first wires, signals according to electrostatic capacitance at nodes of the plurality of first electrodes as well as the at least one set of auxiliary electrodes and the plurality of second electrodes, and detects a contact position at any one of nodes of the plurality of first electrodes and the plurality of second electrodes in accordance with the acquired signals.

4. The touch panel display device according to claim 1, wherein
the touch panel receives touch operation by means of an active pen configured to output a drive signal,
the touch panel further includes a controller connected to the plurality of first wires and the plurality of second wires,
the plurality of first electrodes, the at least one set of auxiliary electrodes, and the plurality of second electrodes each receive the drive signal,
the controller acquires, via the plurality of first wires and the plurality of second wires, signals according to signal intensity of the drive signals received by the plurality of first electrodes, the at least one set of auxiliary electrodes, and the plurality of second electrodes, and detects a contact position of the active pen at any one of nodes of the plurality of first electrodes and the plurality of second electrodes in accordance with the acquired signals.

5. The touch panel display device according to claim 3, wherein the controller removes a noise component included in a signal acquired from each of the first wires in accordance with a signal acquired from the first wire for at least a remaining one of the first electrodes having an end that is adjacent to the end connected to the first wire and is connected to a corresponding one of the first wires, or signals acquired from the first wire for the at least one remaining first electrode and the first wire for the auxiliary electrode having an end that is adjacent to the end connected to the first wire and is connected to a corresponding one of the first wires.

6. The touch panel display device according to claim 1, wherein the plurality of first electrodes and the at least one set of auxiliary electrodes are provided on a first surface of the substrate, and the plurality of second electrodes is provided on a second surface of the substrate.

7. The touch panel display device according to claim 1, wherein
the touch panel further includes an insulating layer,
the plurality of first electrodes, the at least one set of auxiliary electrodes, the plurality of second electrodes, and the insulating layer are provided on a first surface of the substrate, and
the insulating layer is disposed between the plurality of first electrodes as well as the at least one set of auxiliary electrodes and the plurality of second electrodes.
